(19) United States
(12) Patent Application Publication
(10) Pub. No.: US 2005/0231579 A1
(43) Pub. Date: Oct. 20, 2005

(54) Image forming apparatus

(75) Inventors: Yoshitaka Kitaoka, Osaka (JP); Noriyuki Tajima, Osaka (JP); Atsushi Sogami, Sanda-shi (JP); Hiroshi Terada, Ikoma-shi (JP); Yuzo Kawano, Ogori-shi (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/106,625

(22) Filed: Apr. 15, 2005

(30) Foreign Application Priority Data
Apr. 20, 2004 (JP) 2004-124748

(51) Int. Cl. B41J 2/205

(52) U.S. Cl. 347/104

(57) ABSTRACT

In manual copying mode, recording paper that has undergone image formation passes along a main body ejection path and is ejected onto a main body ejection platform of a main body ejection section by main body ejection rollers, and in automatic copying mode and external input print mode, recording paper that has undergone image formation passes along a top ejection path and is ejected onto a top ejection platform of a top ejection section by top ejection rollers. By thus having recording paper with a high image forming frequency that has undergone image formation by means of the aforementioned automatic copying mode or external input print mode ejected into top ejection section positioned on the upper part of the main body of the apparatus by means of top ejection mode, checking and removal of recording paper are facilitated and convenience is improved.

### BACKGROUND OF THE INVENTION

1. Field of the Invention

The present invention relates to an image forming apparatus, and more particularly to an image forming apparatus useful for use in a multifunctional composite machine that has a copying function that copies paper documents (sheet source documents), book source documents, and so forth, a print function that prints out electronic data and so forth transmitted from a personal computer (PC) or the like, a facsimile function that transmits and receives to/from a facsimile device (FAX), and so forth.

2. Description of the Related Art

In line with the digitalization of text data and image data in recent years, by far the most frequent kind of printout by multifunctional image forming apparatuses of this kind used in general offices and so forth is that of electronic data transmitted from a PC, FAX, or similar device.

While the trend is for the frequency of such electronic data printout to continue to increase among multifunctional image forming apparatuses of this kind, the copying of paper documents, book source documents, and the like is also necessary from time to time, and therefore a reading section for reading these source documents must also be provided in these apparatuses.

With a conventional image forming apparatus of this kind, a copied or printed recording medium that has undergone image formation is generally ejected onto and held on an ejection tray positioned so as to project into an ejection section at the side of the main body of the apparatus.

Also, on the side of the main body of this kind of conventional image forming apparatus, there is generally provided a manual tray that is deployed only in special cases such as manual feeding, and is stored during other kinds of feeding. This manual tray is often positioned on the opposite side from the aforementioned ejection section side of the main body of the apparatus.

However, with an image forming apparatus having this kind of configuration, since it is necessary to secure projection areas for the aforementioned ejection tray and manual tray at the side of the main body of the apparatus, the required footprint (installation area) is larger than it appears.

For this reason, in recent years an image forming apparatus has been proposed in a patent document (Unexamined Japanese Patent Publication No. 2003-307996) that has a configuration whereby a space is formed in the waist section of the main body of the apparatus between the reading section positioned on the top of the main body of the apparatus and an image forming section positioned below this reading section, and an ejection section is provided in this space in the waist section of the main body of the apparatus.

An advantage of this image forming apparatus is that, since a recording medium fed from a feeding section below the image forming section is ejected into an ejection section positioned in a space in the waist section of the main body of the apparatus, nothing projects from the side of the main body of the apparatus except the aforementioned manual tray, and the footprint can be kept small.

However, while the footprint of this image forming apparatus can be kept small, there is an essential irrationality in the configuration in that it is awkward to handle a recording medium that has undergone image formation because there is an operation panel operated by the user and a reading section above the ejection section.

That is to say, the image forming apparatus described in the patent document has a configuration such that a recording medium that has undergone image formation, ejected into and held in the ejection section positioned in the waist section of the main body of the apparatus, is hidden behind the reading section, the operation panel on the front of the main body of the apparatus, or the like.

Consequently, with this image forming apparatus, the configuration makes it difficult to check the state of a recording medium that has undergone image formation by means of electronic data from a PC or the like for which image forming frequency is higher than for copying of paper documents, book source documents, or the like, and makes it difficult to remove an ejected recording medium from the ejection section.

Furthermore, with this image forming apparatus, since the ejection section is formed in a space in the waist section of the main body of the apparatus, the housing structure and exterior configuration are complicated.

Moreover, with this image forming apparatus, it is necessary to form a large ejection section space in order to facilitate handling of recording media on which electronic data has been printed out from a PC or the like with a high image forming frequency as described above, and therefore extra costs are necessary in order to maintain the strength of the main body of the apparatus, and so forth.

It is thus desirable for an image forming apparatus of this kind to have a configuration that allows the footprint of the main body of the apparatus to be kept small while also facilitating checking and removal of a recording medium that has undergone image formation.

As an image forming apparatus that meets this need, an image forming apparatus has been proposed in a patent document (Unexamined Japanese Patent Publication No. HEI 5-147802) in which the ejection section used to eject a recording medium that has undergone image formation is positioned on the upper part of a source document cover for covering a source document placed on the source document holding platform of the reading section thereof.

In the image forming apparatus described in this patent document, since a recording medium that has undergone image formation is ejected into an ejection section positioned on the upper part of the source document cover, the footprint of the main body of the apparatus can be made small and checking and removal of a recording medium that has undergone image formation can be performed easily.

However, with an image forming apparatus with an ejection section provided on the upper part of the source document cover, the source document cover is greatly displaced from its normal position when a thick source document such as a book source document is read. Consequently, with an image forming apparatus having this kind of configuration, positional displacement occurs between the recording medium ejection path and the ejection section on the top of the source document cover when a thick source document such as a book source document is read.

Thus, in the image forming apparatus described in the patent document, the recording medium ejection path leading from the image forming section to the top of the main body of the apparatus is positioned in the vicinity of the axis of rotation of the source document cover, and by limiting the opening/closing direction of the source document cover, it is possible for a recording medium to be ejected even when the source document cover is opened.

Also, with the image forming apparatus described in this patent document, a lock mechanism is provided that applies a lock to prevent opening of the source document cover when a copy directive is issued while the source document cover is closed, preventing sheet jams due to inadvertent opening of the source document cover, and improving ejection reliability.

However, with the image forming apparatus described in this patent document, since the recording medium ejection path is positioned in the vicinity of the axis of rotation of the source document cover, the configuration of the recording medium ejection path leading from the image forming section to the ejection section on the top of the main body of the apparatus tends to become complicated.

Also, with this image forming apparatus, combinations of the source document cover opening/closing direction and the post-image-formation recording medium ejection direction are limited, making it difficult to devise a configuration that provides for various kinds of image forming section and reading section configurations, and thus resulting in a low degree of flexibility of layout.

Also, with multifunctional image forming apparatuses widely used at the present time of progress in digitalization, images from a variety of sources may be formed rather than performing simple paper document copying. However, the source document cover lock mechanism in the image forming apparatus described in this patent document only takes into consideration a single-function case in which a paper document placed on the source document holding platform of the reading section is copied.

Consequently, if the lock mechanism in the image forming apparatus described in this patent document is used in a multifunctional image forming apparatus, the source document cover will simply be locked even if an image forming operation from a source other than a copying source is started.

Therefore, with a multifunctional image forming apparatus using this kind of conventional lock mechanism, since the source document cover is locked without regard to the kind of source for which image forming is performed, there is a possibility of faults occurring, such as a case where a source document is trapped inside the reading section during a copying operation and cannot be removed.

### SUMMARY OF THE INVENTION

It is an object of the present invention to provide a highly convenient image forming apparatus that enables a recording medium that has undergone image formation to be checked and removed easily without resulting in complication of the ejection path or a decrease in layout flexibility.

According to an aspect of the invention, an image forming apparatus has a receiving section that receives image information from an external source; a reading section that is equipped with a source document holding platform and reads a source document placed on the aforementioned source document holding platform; an image forming section that forms an image on a recording medium; a top ejection section positioned on the upper part of the main body of the apparatus that holds a recording medium that has undergone image formation; and a main body ejection section positioned in a different area of the main body of the apparatus from the aforementioned top ejection section that holds a recording medium that has undergone image formation; and this image forming apparatus is provided with an ejection mode switching section that switches to a top ejection mode in which a recording medium that has undergone image formation is ejected into the aforementioned top ejection section in the case of image formation by means of image information from the aforementioned external source, and switches to a main body ejection mode in which a recording medium that has undergone image formation is ejected into the aforementioned main body ejection section in the case of image formation by means of image information from the aforementioned reading section.

According to another aspect of the invention, an image forming apparatus has a reading section that is equipped with a source document holding platform and reads a source document placed on the aforementioned source document holding platform; an automatic document feeder that is equipped with a source document feeding section and reads a feed source document fed by the aforementioned source document feeding section; an image forming section that forms an image on a recording medium; a top ejection section positioned on the upper part of the main body of the apparatus that holds a recording medium that has undergone image formation; and a main body ejection section positioned in a different area of the main body of the apparatus from the aforementioned top ejection section that holds a recording medium that has undergone image formation; and this image forming apparatus is provided with an ejection mode switching section that switches to a top ejection mode in which a recording medium that has undergone image formation is ejected into the aforementioned top ejection section in the case of image formation by means of image information from the aforementioned automatic document feeder, and switches to a main body ejection mode in which a recording medium that has undergone image formation is ejected into the aforementioned main body ejection section in the case of image formation by means of image information from the aforementioned reading section.

### BRIEF DESCRIPTION OF THE DRAWINGS

The above and other objects and features of the invention will appear more fully hereinafter from a consideration of the following description taken in conjunction with the accompanying drawing wherein one example is illustrated by way of example, in which:

FIG. 1 is a schematic cross-sectional drawing showing the overall configuration of an image forming apparatus according to Embodiment 1 of the present invention;

FIG. 2 is a schematic cross-sectional drawing showing the overall configuration for explaining the operating situation in the manual copying mode of an image forming apparatus according to Embodiment 1;

FIG. 3 is a schematic cross-sectional drawing showing the configuration of an automatic document feeder for explaining the operating situation in the automatic copying mode of an image forming apparatus according to Embodiment 1;

FIG. 4 is a schematic configuration diagram showing one example of the ejection mode switching section of an image forming apparatus according to Embodiment 1;

FIG. 5 is a schematic configuration diagram showing one example of the source document cover lock section of an image forming apparatus according to Embodiment 1;

FIG. 6 is a flowchart showing an example of operation in the external input print mode of an image forming apparatus according to Embodiment 1;

FIG. 7 is a flowchart showing an example of operation in the manual copying mode of an image forming apparatus according to Embodiment 1;

FIG. 8 is a schematic configuration diagram showing the configuration of the ejection mode switching section of an image forming apparatus according to Embodiment 2;

FIG. 9 is a schematic cross-sectional drawing showing the overall configuration of an image forming apparatus according to Embodiment 3;

FIG. 10 is a schematic cross-sectional drawing showing the overall configuration for explaining the operating situation in the manual copying mode in which a thick book source document is copied in an image forming apparatus according to Embodiment 3;

FIG. 11 is a schematic cross-sectional drawing showing the overall configuration of an image forming apparatus according to Embodiment 4; and

FIG. 12 is a schematic cross-sectional drawing showing the overall configuration of an image forming apparatus according to Embodiment 5.

### DESCRIPTION OF THE PREFERRED EMBODIMENTS

With reference now to the accompanying drawings, embodiments of the present invention will be explained in detail below. In the drawings, configuration elements and equivalent parts that have identical configurations or function are assigned the same codes, and descriptions thereof are not repeated.

(Embodiment 1)

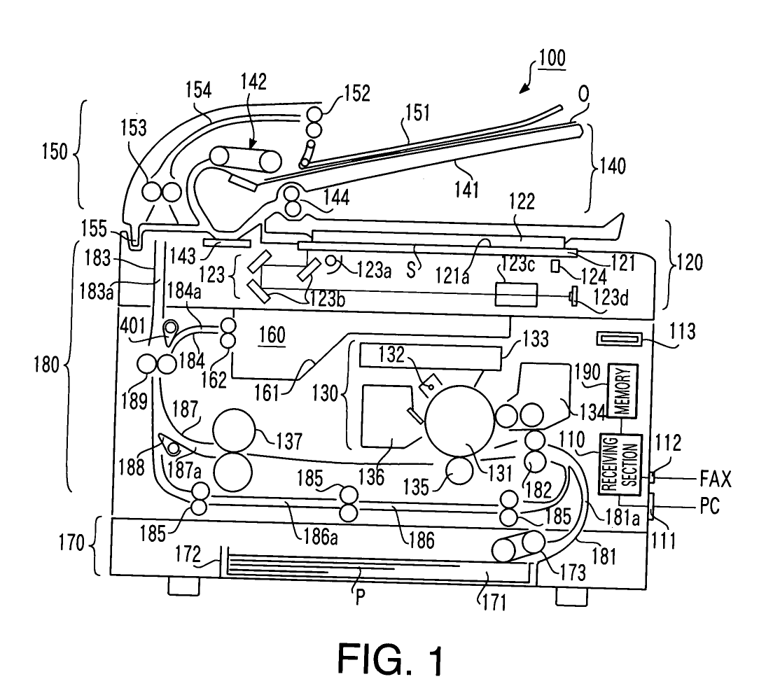

FIG. 1 is a schematic cross-sectional drawing showing the overall configuration of an image forming apparatus according to Embodiment 1 of the present invention. An image forming apparatus according to Embodiment 1 has a configuration as a multifunctional composite machine having a copying function that copies paper documents, book source documents, and so forth, a print function that prints out electronic data and so forth transmitted from a PC or the like, a facsimile function that transmits and receives to/from a FAX or the like, and so forth.

That is to say, as shown in FIG. 1, this image forming apparatus 100 includes a receiving section 110, a reading section 120, an image forming section 130, an automatic document feeder 140, a top ejection section 150, a main body ejection section 160, a feeding section 170, a transporting system 180, and so forth.

Receiving section 110 receives image information input from an external device such as a PC, FAX, or storage medium (memory card) via a LAN (including a wireless LAN) or public network. Image forming apparatus 100 is equipped with a LAN port 111 to which a LAN cable is connected, a modular connector 112 to which a public network is connected, and a card slot 113 into which a memory card is inserted.

Reading section 120 is composed of a source document holding platform (contact glass) 121 on which a sheet source document S (or book source document BO described later herein) to be copied is placed manually by the user, a source document cover 122 that covers sheet source document S (or book source document BO) placed on a source document holding surface 121a, a scanning optical system 123 that scans and reads an image of sheet source document S, and so forth. Scanning optical system 123 of this example is composed of a light source 123a, mirrors 123b, a lens 123c, an image pickup device (CCD) 123d, and so forth. Source document cover 122 has a configuration combining a source document ejection tray of automatic document feeder 140 described later herein.

Image forming section 130 is composed of a photosensitive body 131, an electrifier 132, an exposure apparatus 133, a developing apparatus 134, a transfer roller 135, a cleaning apparatus 136, a fixing apparatus 137, and so forth.

Automatic document feeder 140 is composed of a source document feed tray 141 as a source document holding platform on which feed source documents O to be automatically fed are set, source document feed rollers 142 as a source document feeding section that separates and feeds set feed source documents O one by one, a scanner 143 that reads an image of a separated and fed feed source document O, source document ejection rollers 144 that eject a feed source document O for which image reading has been completed, and so forth. Automatic document feeder 140 of this example is configured so that a feed source document O is ejected onto the top of source document cover 122 by means of source document ejection rollers 144. Automatic document feeder 140 of this example is configured so as to open and close freely with respect to the main body of the apparatus together with source document cover 122.

Top ejection section 150 is equipped with a top ejection platform 151 positioned on the upper part of the main body of image forming apparatus 100 that holds recording paper P that has undergone image formation described later herein, and top ejection rollers 152 that eject recording paper P that has undergone image formation onto top ejection platform 151. Top ejection section 150 also includes top transport rollers 153 that transport recording paper P that has undergone image formation toward top ejection rollers 152, and top ejection guide plates 154 that guide recording paper P that has undergone image formation transported toward top ejection rollers 152 by top transport rollers 153. Top ejection platform 151 of this example also serves as a source document pressing plate that presses a feed source document O set on source document feed tray 141. Top ejection section 150 of this example is structurally integral with automatic document feeder 140.

Main body ejection section 160 includes a main body ejection platform 161 positioned in a main body area of image forming apparatus 100 different from top ejection section 150 that holds recording paper P that has undergone image formation, and main body ejection rollers 162 that eject recording paper P that has undergone image formation onto main body ejection platform 161. As shown in FIG. 1, main body ejection section 160 of image forming apparatus 100 according to Embodiment 1 is positioned in a space formed in the waist section of the main body of the apparatus between reading section 120 and image forming section 130.

Feeding section 170 is composed of a cassette housing section 172 for holding a paper feed cassette 171 containing recording paper P as a recording medium, a separating and feeding apparatus 173 that separates and feeds individual sheets of recording paper P held in paper feed cassette 171, and so forth.

Transporting system 180 is equipped with feed guide plates 181 that guide recording paper P from feeding section 170 toward image forming section 130. A feed path 181a is formed by these feed guide plates 181. At the exit of this feed path 181a are positioned registration rollers 182 that transport recording paper P to image forming section 130 at predetermined timing.

Transporting system 180 is also equipped with top ejection guide plates 183 that guide recording paper P ejected from fixing apparatus 137 of image forming section 130 toward top ejection section 150. A top ejection path 183a is formed by these top ejection guide plates 183.

Transporting system 180 is also equipped with main body ejection guide plates 184 that guide recording paper P ejected from fixing apparatus 137 of image forming section 130 toward main body ejection section 160. A main body ejection path 184a is formed by these main body ejection guide plates 184.

Here, an ejection mode in which recording paper P ejected from fixing apparatus 137 of image forming section 130 is ejected toward top ejection section 150 via top ejection path 183a is called top ejection mode, and an ejection mode in which recording paper P ejected from fixing apparatus 137 of image forming section 130 is ejected toward main body ejection section 160 via main body ejection path 184a is called main body ejection mode.

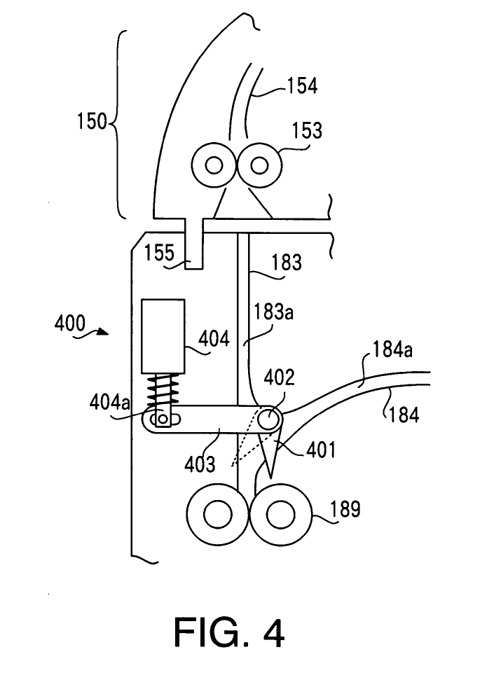

At the branch of top ejection path 183a and main body ejection path 184a is positioned an ejection path switching lug 401 of an ejection mode switching section 400 that switches between top ejection mode and main body ejection mode (see FIG. 4).

Transporting system 180 of this example also has reverse transport rollers 185 that transport recording paper P that has undergone image formation to feed path 181a with its image formation surface reversed, and a reverse transport path 186a formed by reverse transport guide plates 186.

At the confluence of this reverse transport path 186a and an ejection transport path 187a formed by ejection guide plates 187 that guide recording paper P ejected from fixing apparatus 137 of image forming section 130 is positioned a reverse switching lug 188 that switches the transport path of recording paper P that has temporarily left ejection transport path 187a toward reverse transport path 186a.

On the ejection direction upstream side of ejection path switching lug 401 are positioned forward/reverse rollers 189 that transport recording paper P in the ejection direction or reverse transportation direction.

Next, the operation of an image forming apparatus according to Embodiment 1 will be described.

This image forming apparatus 100 has three print modes: a manual copying mode, an automatic copying mode, and an external input print mode.

Manual copying mode is a print mode in which a sheet source document S or book source document BO placed on source document holding surface 121a is copied by means of image information read by CCD 123d of reading section 120.

Automatic copying mode is a print mode in which a feed source document O set on source document feed tray 141 is copied by means of image information read by scanner 143 of automatic document feeder 140.

External input print mode is a print mode in which printout is performed by means of image information from an external device such as a PC, FAX, or memory card, input to receiving section 110.

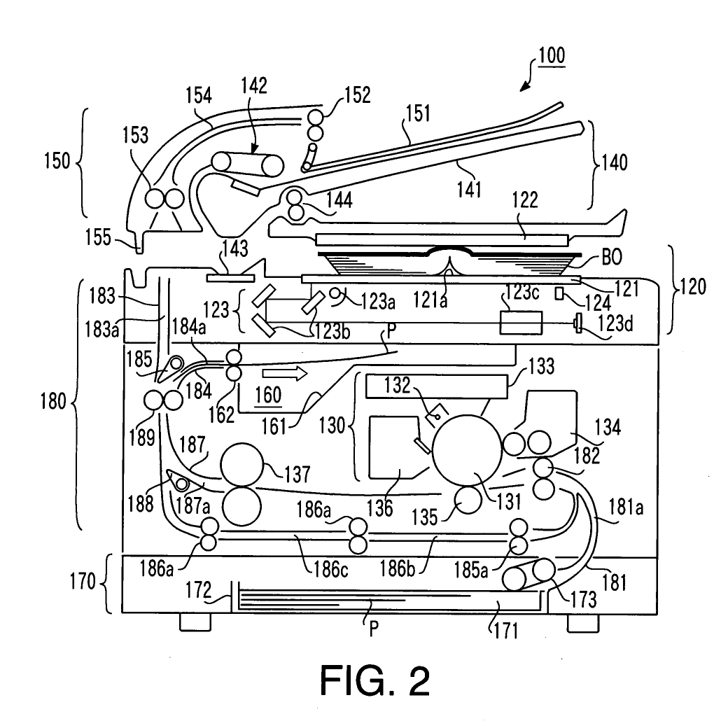

In manual copying mode, as shown in FIG. 2, source document cover 122 of reading section 120 is first opened together with automatic document feeder 140, exposing source document holding surface 121a of source document holding platform 121. Then the user manually places a source document (here, a book source document BO) to be copied on this exposed source document holding surface 121a.

Reading section 120 has a source document size sensor 124 as a manual source document detection device that detects the presence of a sheet source document S or book source document BO placed on source document holding platform 121. That is to say, in this image forming apparatus 100, the presence or absence of a sheet source document S or book source document BO is detected by whether or not source document size sensor 124 detects the size of a source document placed on source document holding surface 121a and outputs a detection signal.

In FIG. 2, when the user presses the Copy button on an operation panel (not shown) of the main body of the apparatus while it is detected by source document size sensor 124 that a book source document BO has been placed on source document holding surface 121a, scanning optical system 123 operates and book source document BO image data is read by CCD 123d. Book source document BO image data read by this CCD 123d is converted to print data by an image processing apparatus (not shown), and then input to exposure apparatus 133 at predetermined timing.

Meanwhile, as a result of pressing the Copy button, photosensitive body 131 rotates in the predetermined direction, and the surface of photosensitive body 131 is charged uniformly by electrifier 132. Exposure apparatus 133 irradiates the surface of this uniformly charged photosensitive body 131 with print data converted by the image processing apparatus as a laser beam. By means of this laser irradiation, an electrostatic latent image of book source document BO is formed on the surface of photosensitive body 131.

This electrostatic latent image is made into a visible image (a toner image) by means of toner supplied from developing apparatus 134. This toner image is then transferred by transfer roller 135 to recording paper P fed by registration rollers 182, and then fixed onto recording paper P by fixing apparatus 137.

Recording paper P onto which the image of book source document BO has been copied in this way passes along main body ejection path 184a and is ejected and placed onto main body ejection platform 161 of main body ejection section 160 by main body ejection rollers 162 as shown by the solid line in FIG. 2.

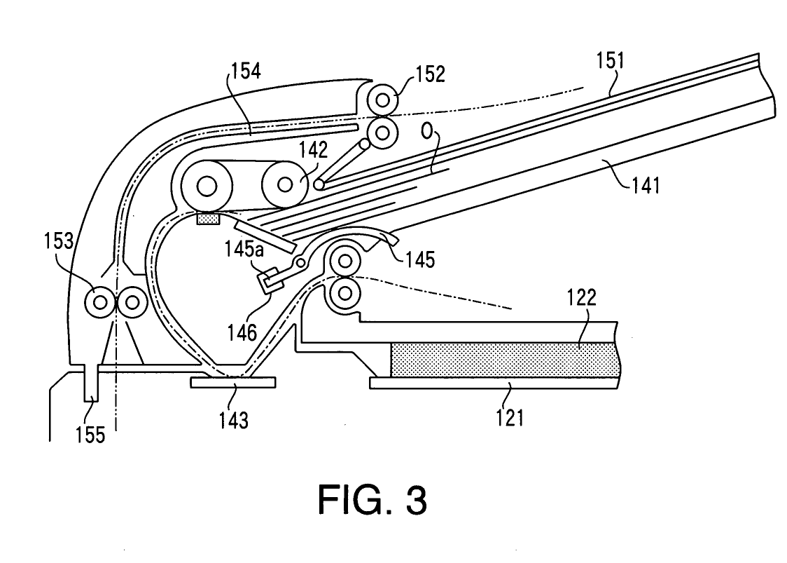

In automatic copying mode, when feed source documents O to be fed automatically are set on source document feed tray 141 of automatic document feeder 140, as shown in FIG. 3, an actuator 145 attached to source document feed tray 141 so as to be able to swing freely is pressed against feed source documents O and swings in a clockwise direction. Through the swinging of this actuator 145, a feed source document sensor 146 functioning as a feed source document detection device that detects the presence of a feed source document O to be fed by automatic document feeder 140 is turned on.

Feed source document sensor 146 in this example is composed of a light emitting element and a photoreceptor element, and is configured so as to be turned on and off by the advance or retreat of swinging end 145a of actuator 145 with respect to the light path between the two elements. When feed source document sensor 146 is turned on, preparation for light emission by the lamp of scanner 143 that reads feed source document O image information, and so forth, is performed.

When the user presses the Copy button on the operation panel on the main body of the apparatus while feed source document sensor 146 is on, a feed source document O on source document feed tray 141 is fed automatically as shown by the dot-dash line in FIG. 3. By this means, feed source document O is transported while being held in close contact with the source document reading glass of scanner 143, and the feed source document O image is read. When feed source document O has been read, it is ejected by source document ejection rollers 144 onto the top of source document cover 122 also serving as the source document ejection tray of automatic document feeder 140.

Image information (image data) of feed source document O read by scanner 143 of automatic document feeder 140 in this way is stored (accumulated) in memory 190 functioning as a storage section located inside the main body of the apparatus (see FIG. 1). Image data stored (accumulated) in memory 190 is converted to print data by an image processing apparatus (not shown) and input to exposure apparatus 133 at predetermined timing.

As in the above-described automatic copying mode, the surface of uniformly charged photosensitive body 131 is irradiated with the print data input to exposure apparatus 133 as a laser beam at predetermined timing, and the print data is fixed onto recording paper P as a toner image by fixing apparatus 137.

In this automatic copying mode, recording paper P that has undergone image formation ejected from fixing apparatus 137 is transported toward top ejection section 150 via top ejection path 183a. This recording paper P is transported along top ejection guide plates 154 by top transport rollers 153 as shown by the dot-dot-dash line in FIG. 3, and is ejected and placed onto top ejection platform 151 positioned on the top part of the main body of image forming apparatus 100 by top ejection rollers 152.

In external input print mode, image information (image data) input to receiving section 110 from an external device such as a PC, FAX, or memory card is stored (accumulated) in memory 190 provided as a storage section located in the main body of the apparatus in the same way as in automatic copying mode. Image data stored (accumulated) in this memory 190 is converted to print data by an image processing apparatus (not shown) and input to exposure apparatus 133 at predetermined timing.

Also, in this external input print mode, as in the case of automatic copying mode, recording paper P that has undergone image formation ejected from fixing apparatus 137 is transported toward top ejection section 150 via top ejection path 183a, and is ejected and placed onto top ejection platform 151 by top ejection rollers 152.

In this image forming apparatus 100, as described above, in manual copying mode recording paper P that has undergone image formation passes along main body ejection path 184a and is ejected and placed onto main body ejection platform 161 of main body ejection section 160 by main body ejection rollers 162 as shown by the solid line in FIG. 2.

In automatic copying mode and external input print mode, on the other hand, recording paper P that has undergone image formation passes along top ejection path 183a and is ejected and placed onto top ejection platform 151 of top ejection section 150 by top ejection rollers 152 as shown by the dot-dot-dash line in FIG. 3.

That is to say, in this image forming apparatus 100, recording paper P that has undergone image formation in automatic copying mode or external input print mode, which have a high image formation frequency, is ejected into top ejection section 150 positioned on the top of the main body of the apparatus by means of top ejection mode.

Therefore, with this image forming apparatus 100, recording paper P with a high image formation frequency of this kind can easily be checked and removed, and convenience is improved.

Also, in manual copying mode, recording paper P that has undergone image formation by means of image information from reading section 120 is ejected onto main body ejection platform 161 of main body ejection section 160, which is not affected by manipulation of a sheet source document S or book source document BO placed on source document holding platform 121 in main body ejection mode.

Therefore, with this image forming apparatus 100, there is no tendency to complicate the ejection path, or reduce the layout flexibility, of recording paper P that has undergone image formation in manual copying mode.

Here, switching between recording paper P top ejection path 183a in top ejection mode and recording paper P main body ejection path 184a in main body ejection mode is performed by means of above-described ejection path switching lug 401 of ejection mode switching section 400.

FIG. 4 is a schematic configuration diagram showing one example of ejection mode switching section 400 of this image forming apparatus 100. As shown in FIG. 4, ejection path switching lug 401 of ejection mode switching section 400 is attached to a spindle 402 pivoted at the branch of top ejection path 183a and main body ejection path 184a of the main body of the apparatus.

A switching arm 403 is attached to spindle 402. This switching arm 403 and ejection path switching lug 401 are configured integrally via spindle 402. The free end of switching arm 403 is connected in freely swinging fashion to an actuator 404a of a switching solenoid 404 provided in the main body of the apparatus.

When the print mode of image forming apparatus 100 is automatic copying mode or external input print mode, switching solenoid 404 is in the off state (normal state) When this switching solenoid 404 is in the off state, ejection path switching lug 401 moves to a position in which top ejection path 183a is opened, as shown by the solid line in FIG. 4, and the recording paper P ejection mode is switched to the top ejection mode shown in FIG. 1.

On the other hand, when the print mode of image forming apparatus 100 is manual copying mode, switching solenoid 404 is in the on state (excited state). That is to say, switching solenoid 404 of this example goes to the on state when source document size sensor 124 of reading section 120 detects a sheet source document S or book source document BO placed on source document holding platform 121 and outputs a detection signal. When switching solenoid 404 is in the on state, ejection path switching lug 401 moves to a position in which main body ejection path 184a is opened, as shown by the dotted line in FIG. 4, and the recording paper P ejection mode is switched to the main body ejection mode shown in FIG. 2.

In this image forming apparatus 100, if source document cover 122 is opened by mistake when the print mode is automatic copying mode or external input print mode that is, when the recording paper P ejection mode is switched to the top ejection mode shown in FIG. 1—top ejection path 183a and top ejection section 150 will become separated and a sheet jam will occur, as shown in FIG. 2.

To prevent the occurrence of such sheet jams, this image forming apparatus 100 is equipped with a source document cover lock section that latches onto source document cover 122 at a predetermined position in top ejection mode.

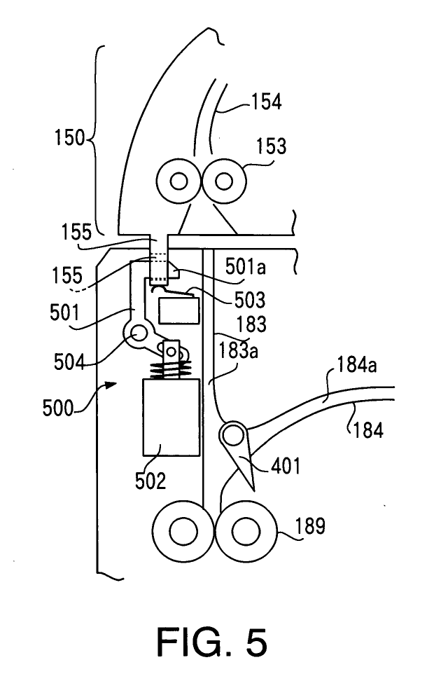

FIG. 5 is a schematic configuration diagram showing one example of the source document cover lock section in this image forming apparatus 100. As shown in FIG. 5, this source document cover lock section 500 includes a lock arm 501, a lock solenoid 502, a cover position sensor 503, and so forth.

Lock arm 501 pivots so as to swing freely on a spindle 504 attached to the main body of the apparatus. Lock solenoid 502 is fitted to the main body of the apparatus, and the base end of lock arm 501 is linked in a freely swinging fashion to the actuator thereof.

Cover position sensor 503 comprises a microswitch, and the end of a lock projection 155 projecting from top ejection section 150 that is opened and closed together with source document cover 122 faces the actuator of this microswitch. A hook hole 155a is bored in this lock projection 155.

At the free end of lock arm 501 is formed a hook section 501a that goes into and comes out of hook hole 155a of lock projection 155 according to whether lock solenoid 502 is on or off. As shown in FIG. 1, this lock solenoid 502 goes to the on state (excited state) when top ejection section 150 is closed together with source document cover 122 and the end of lock projection 155 pushes the actuator of cover position sensor 503, and the print mode of image forming apparatus 100 is automatic copying mode or external input print mode.

Also, as shown in FIG. 1, lock solenoid 502 goes to the off state (normal state) when top ejection section 150 is closed together with source document cover 122 and the end of lock projection 155 pushes the actuator of cover position sensor 503, and the print mode of image forming apparatus 100 is manual copying mode.

Furthermore, as shown in FIG. 2, lock solenoid 502 goes to the off state (normal state) when top ejection section 150 is opened together with source document cover 122, and the end of lock projection 155 of top ejection section 150 is moved away from the actuator of cover position sensor 503.

When lock solenoid 502 is in the on state, hook section 501a of lock arm 501 is hooked in hook hole 155a of lock projection 155, as shown by the solid line in FIG. 5, and source document cover 122 is latched in a predetermined position of the main body of the apparatus together with top ejection section 150.

When lock solenoid 502 is in the off state, hook section 501a of lock arm 501 is released from hook hole 155a of lock projection 155, and source document cover 122 is placed in a freely opening/closing state with respect to the main body of the apparatus together with top ejection section 150.

Thus, with this image forming apparatus 100, source document cover 122 is latched in a predetermined position in automatic copying mode or external input print mode (in top ejection mode). Therefore, with this image forming apparatus 100, it is possible to prevent the occurrence of sheet jams due to inadvertent opening of source document cover 122 when recording paper P is ejected into top ejection section 150.

When reading section 120 performs reading of a thick book source document BO, source document cover 122 is half-open, as shown in FIG. 2, and therefore source document cover 122 is not latched to the main body of the apparatus in this state even if lock solenoid 502 is turned on.

However, when reading section 120 performs reading of a thin sheet source document S, source document cover 122 is closed, as shown in FIG. 1, and therefore source document cover 122 is latched to the main body of the apparatus in this state when lock solenoid 502 is turned on.

Consequently, with this image forming apparatus 100, if, for example, lock solenoid 502 is turned on by a directive for image forming by means of image information from an external source during an operation of reading section 120 in which sheet source document S reading is being performed, and source document cover 122 is latched to the main body of the apparatus, this sheet source document S will be trapped between source document holding platform 121 and source document cover 122 and will not be able to be removed.

As stated above, source document cover 122 is never latched to the main body of the apparatus when reading section 120 is performing book source document BO reading, but if lock solenoid 502 is turned on at this time, hook section 501a of lock arm 501 will block the path of forward and backward movement of lock projection 155.

Thus, in this image forming apparatus 100, source document cover 122 is fixed at a predetermined position for the duration of a predetermined period after operation of reading section 120 ends—that is, after the user removes a sheet source document S or book source document BO for which reading has been completed.

That is to say, this image forming apparatus 100 is configured so that lock solenoid 502 goes to the off state when source document size sensor 124 of reading section 120 detects a sheet source document S or book source document BO placed on source document holding platform 121 and outputs a detection signal.

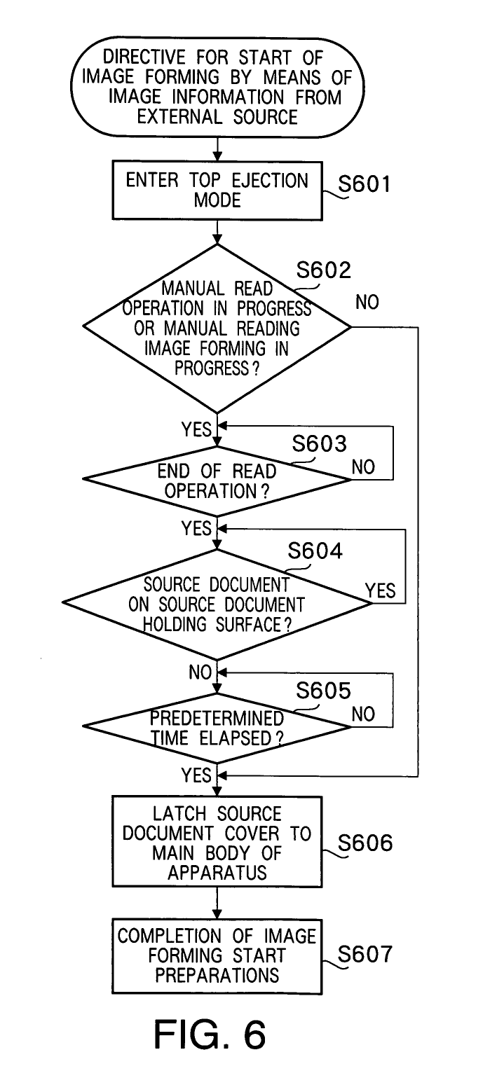

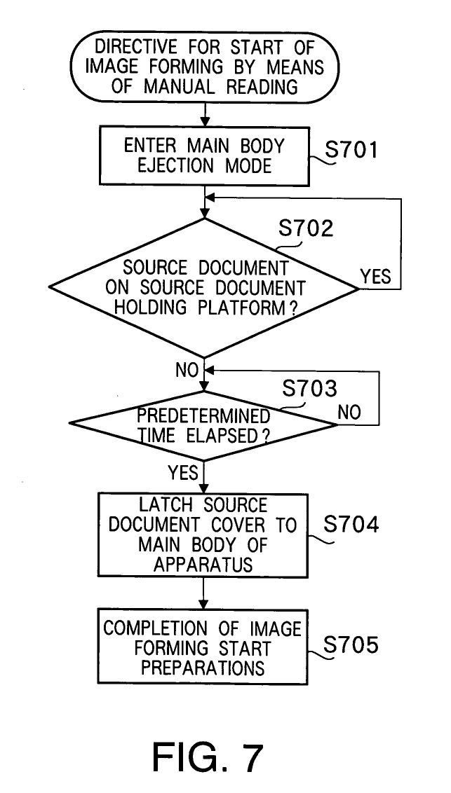

FIG. 6 is a flowchart showing an example of operation in the external input print mode of this image forming apparatus 100, and FIG. 7 is a flowchart showing an example of operation in the manual copying mode of this image forming apparatus 100.

First, the example of operation in external input print mode shown in FIG. 6 will be described.

In FIG. 6, when there is a start directive for image forming by means of image information from an external source, the recording paper P ejection mode becomes- top ejection mode (step S601). Then, in this top ejection mode, it is determined whether or not the print mode is “manual copying mode read operation in progress” or “manual reading image forming in progress” (step S602)

If it is determined here that neither “manual copying mode read operation in progress” nor “manual reading image forming in progress” applies (step S602: NO), source document cover 122 is latched to the main body of the apparatus immediately (step S606), and image forming start preparations are completed (step S607).

On the other hand, if it is determined in step S602 that a manual copying mode read operation is in progress or manual reading image forming is in progress (step S602: YES), it is determined whether or not the reading section 120 read operation has ended (step S603).

Then, if it is determined in step S603 that the reading section 120 read operation has ended (step S603: YES), it is determined whether or not there is a sheet source document S or book source document BO on source document holding surface 121a based on the presence or absence of detection signal output from source document size sensor 124 (step S604).

If it is determined here that there is no sheet source document S or book source document BO on source document holding surface 121a (step S604: NO)—that is, if a sheet source document S or book source document BO for which a read operation has ended has been removed from source document holding surface 121a—it is determined whether or not a predetermined time has elapsed (step S605).

After the predetermined time has elapsed (step S605: YES), source document cover 122 is latched to the main body of the apparatus (step S606), and image forming start preparations are completed (step S607).

Next, the example of operation in manual copying mode shown in FIG. 7 will be described.

In FIG. 7, when there is a start directive for image forming by means of manual reading, the recording paper P ejection mode becomes main body ejection mode (step S701). Then, in this main body ejection mode, it is determined whether or not there is a sheet source document S or book source document BO on source document holding surface 121a based on the presence or absence of detection signal output from source document size sensor 124 (step S702).

If it is determined here that there is no sheet source document S or book source document BO on source document holding surface 121a (step S702: NO)—that is, if a sheet source document S or book source document BO for which a read operation has ended has been removed from source document holding surface 121a—it is determined whether or not a predetermined time has elapsed (step S703).

After the predetermined time has elapsed (step S703: YES), source document cover 122 is latched to the main body of the apparatus (step S704), and image forming start preparations are completed (step S705).

Thus, in this image forming apparatus 100, source document cover 122 is not latched in a predetermined position while source document size sensor 124 is detecting that there is a sheet source document S or book source document BO placed on source document holding platform 121, or while a predetermined time has not yet elapsed since reading section 120 operation ended. Therefore, in this image forming apparatus 100, it is possible to prevent a situation in which a sheet source document S in the process of a read operation is trapped between source document holding platform 121 and source document cover 122 and cannot be removed.

Also, in image forming apparatus 100 of this example, since main body ejection section 160 is positioned in the waist section of the main body of the apparatus, the configuration is such that top ejection section 150 and main body ejection section 160 do not project from the side of the main body of the apparatus. Therefore, with this image forming apparatus 100, it is not necessary to secure a projection areas for main body ejection section 160 at the side of the main body of the apparatus, enabling the footprint of the main body of the apparatus to be made smaller. Since main body ejection section 160 in image forming apparatus 100 of this example is used only in infrequent cases in which a source document is placed on source document holding surface 121a to be copied, it need only be small in size, and convenience is not overly affected even if the aperture allowing access is small. Therefore, with this image forming apparatus 100, the strength of the main body of the apparatus can be kept at a high level even though main body ejection section 160 is provided in the waist section of the main body of the apparatus.

With image forming apparatus 100 of this example, image forming start preparations are completed in final steps S607 and S705 in FIG. 6 and FIG. 7, but it goes without saying that image forming by image forming section 130 is actually started at the point at which other preparations for image forming, such as write signal provision and so forth, are also completed.

(Embodiment 2)

Next, an image forming apparatus according to Embodiment 2 of the present invention will be described.

As described above, image forming apparatus 100 enters a state in which source document cover 122 can be latched to the main body of the apparatus when a thin sheet source document S is being read. In this state, major deviation does not occur in the positional relationship between top ejection path 183a of the main body of the apparatus and top ejection section 150. That is to say, a sheet jam never occurs during sheet source document S reading even though recording paper P that has undergone image formation is ejected onto top ejection platform 151 of top ejection section 150.

Therefore, this image forming apparatus 100 can be configured so that ejection path switching lug 401 switches the ejection path after image formation to main body ejection path 184a only when major deviation occurs in the positional relationship between top ejection path 183a of the main body of the apparatus and top ejection section 150, such as during reading of a thick book source document BO.

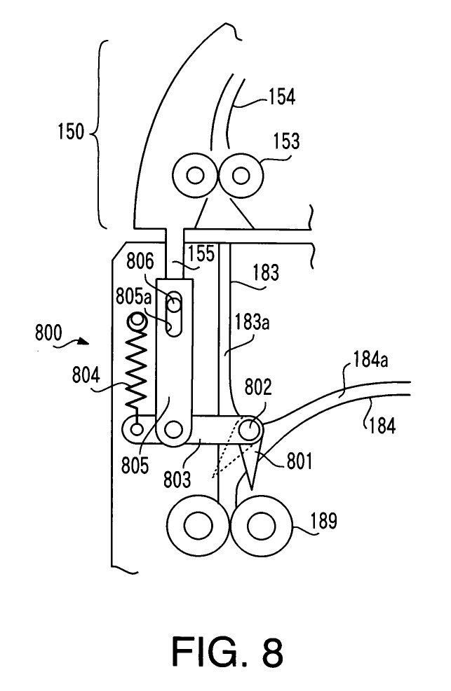

FIG. 8 is a schematic configuration diagram showing the configuration of the ejection mode switching section of an image forming apparatus according to Embodiment 2 of the present invention. As shown in FIG. 8, an ejection mode switching section 800 of this example is configured so that an ejection path switching lug 801 switches the ejection path of recording paper P that has undergone image formation coupled with opening/closing operations of top ejection section 150.

That is to say, ejection path switching lug 801 of ejection mode switching section 800 of this example is attached to a spindle 802 pivoted at the branch of top ejection path 183a and main body ejection path 184a of the main body of the apparatus.

A switching arm 803 is attached to spindle 802. This switching arm 803 and ejection path switching lug 801 are configured integrally via spindle 802. The free end of switching arm 803 is connected to one end of a taut coil spring 804 whose base end is connected to the main body of the apparatus.

A switching linkage arm 805 is connected in freely swinging fashion to switching arm 803. An elongated hole 805a is formed in this switching linkage arm 805. A guide pin 806 fitted into the main body of the apparatus passes through this elongated hole 805a. The lower end of lock projection 155 of top ejection section 150 is opposite the free end of this switching linkage arm 805.

In FIG. 8, when a sheet source document S is read, as a result of top ejection section 150 being closed together with source document cover 122, the lower end of lock projection 155 comes into contact with the free end of switching linkage arm 805, and pushes down switching linkage arm 805 against the tautness of coil spring 804. As a result, ejection path switching lug 801 moves to a position in which top ejection path 183a is opened, as shown by the solid line in FIG. 8, and the recording paper P ejection mode is switched to the top ejection mode shown in FIG. 1.

On the other hand, when a thick book source document BO is read, top ejection section 150 is opened to a half-open position together with source document cover 122, the lower end of lock projection 155 moves away from the free end of switching linkage arm 805, and switching linkage arm 805 is raised by the tautness of coil spring 804. As a result, ejection path switching lug 801 moves to a position in which main body ejection path 184a is opened, as shown by the dotted line in FIG. 8, and the recording paper P ejection mode is switched to the main body ejection mode shown in FIG. 2.

In this image forming apparatus according to Embodiment 2, recording paper P that has undergone image formation is ejected onto top ejection platform 151 of top ejection section 150 without the occurrence of a sheet jam when a thin sheet source document S is read, even in manual copying mode, enabling checking and removal of ejected recording paper P to be carried out easily. Moreover, it is possible to eliminate sheet jams caused by forgetting to switch the ejection path due to erroneous operation by the user or the like.

(Embodiment 3)

Next, an image forming apparatus according to Embodiment 3 of the present invention will be described.

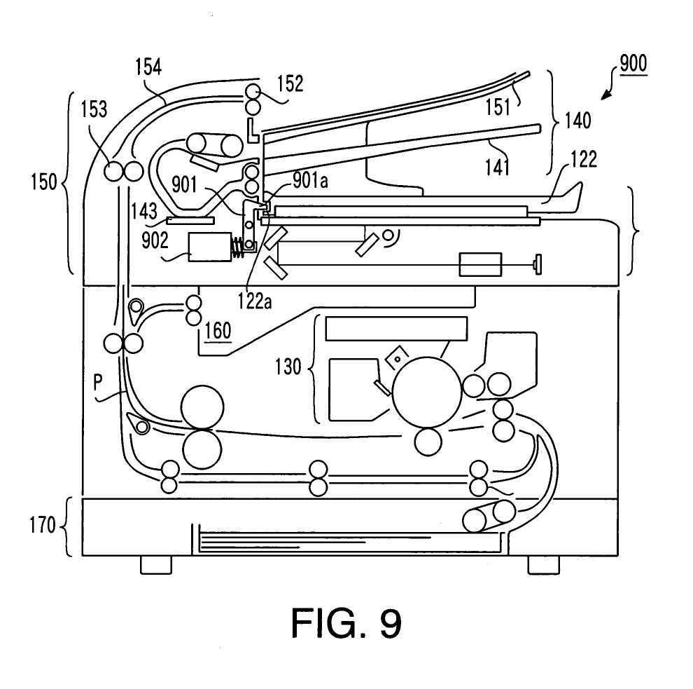

FIG. 9 is a schematic cross-sectional drawing showing the overall configuration of an image forming apparatus according to Embodiment 3. Since image forming apparatus 100 according to Embodiment 1 shown in FIG. 1 and FIG. 2 is configured so that source document cover 122, and automatic document feeder 140 and top ejection section 150, open and close integrally, a certain amount of force is necessary to open and close source document cover 122, imposing a significant burden on the user.

An image forming apparatus according to Embodiment 3 is configured so as to enable this kind of burden on the user to be lightened. As shown in FIG. 9, an image forming apparatus 900 according to Embodiment 3 has a configuration in which (1) the source document feeding section composed of source document feed rollers 142, scanner 143, and source document ejection rollers 144, and (2) source document feed tray 141, are separated in automatic document feeder 140.

Also, this image forming apparatus 900 has a configuration in which (1) top transport rollers 153, top ejection guide plates 154, and top ejection rollers 152, and (2) top ejection platform 151, are separated in top ejection section 150.

Moreover, this image forming apparatus 900 has a configuration in which (1) the source document feeding section of automatic document feeder 140 composed of source document feed rollers 142, scanner 143, and source document ejection rollers 144, (2) top transport rollers 153, top ejection guide plates 154, and top ejection rollers 152 of top ejection section 150, and (3) the main body of the apparatus, are integrated.

Furthermore, this image forming apparatus 900 has a configuration in which source document feed tray 141 of automatic document feeder 140, top ejection platform 151 of top ejection section 150, and source document cover 122, are integrated.

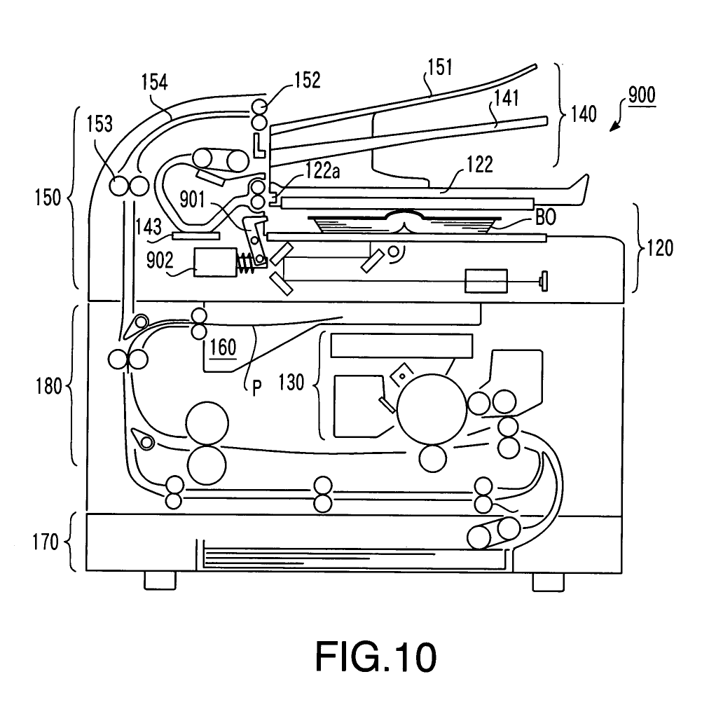

In addition, as shown in FIG. 9 and FIG. 10, this image forming apparatus 900 has a configuration in which only integrated source document feed tray 141, top ejection platform 151, and source document cover 122 are attached to the main body of the apparatus so as to open and close freely.

As this image forming apparatus 900 is configured in this way so that only source document feed tray 141, top ejection platform 151, and source document cover 122 open and close, not so much force is necessary to open and close source document cover 122, and the burden on the user can be lightened.

Also, in this image forming apparatus 900, top ejection section 150 is integral with the main body of the apparatus, and therefore there is no misalignment of the ejection path of recording paper P that has undergone image formation. Furthermore, with this image forming apparatus 900, top ejection rollers 152 of top ejection section 150 can be positioned above top ejection platform 151 even in manual copying mode in which a thick book source document BO is copied, as shown in FIG. 10.

Therefore, with this image forming apparatus 900, it is possible to eject recording paper P that has undergone image formation onto top ejection platform 151 in all print modes, including manual copying mode, automatic copying mode, and external input print mode. Moreover, with this image forming apparatus 900, as with image forming apparatus 100 according to Embodiment 1, it is possible to switch the ejection mode of recording paper P that has undergone image formation between top ejection mode and main body ejection mode as appropriate.

The source document cover lock section of this image forming apparatus 900 is composed of a lock arm 901 and a lock solenoid 902. With this image forming apparatus 900, as shown in FIG. 9, when lock solenoid 902 is in the on state, a hook section 901a of lock arm 901 engages in an indented section 122a provided on the side of source document cover 122, and source document cover 122 is latched to the main body of the apparatus.

Other configuration elements and operations in image forming apparatus 900 of this example are similar to configuration elements and operations of image forming apparatus 100 according to Embodiment 1, and therefore descriptions thereof are omitted here.

(Embodiment 4)

Next, an image forming apparatus according to Embodiment 4 of the present invention will be described.

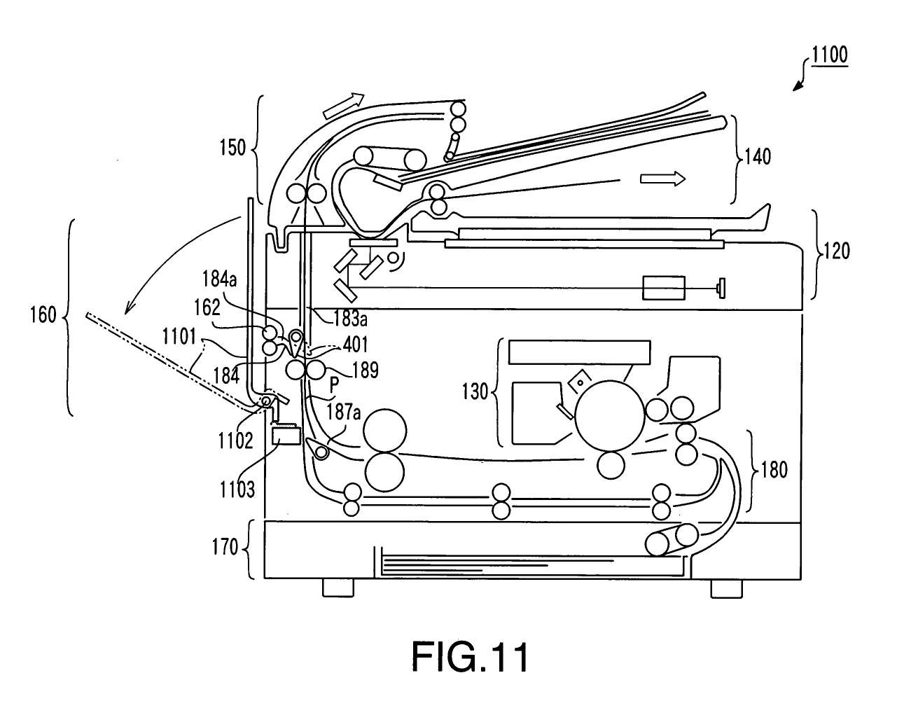

FIG. 11 is a schematic cross-sectional drawing showing the overall configuration of an image forming apparatus according to Embodiment 4. This image forming apparatus according to Embodiment 4 has a configuration in which above-described main body ejection section 160 is provided on the side of the main body of the apparatus.

As shown in FIG. 11, a main body ejection platform 1101 of main body ejection section 160 in this image forming apparatus 1100 is attached to the side of the main body of the apparatus so as to open and close freely by means of a spindle 1102. This main body ejection platform 1101 is normally closed against the side of the main body of the apparatus as shown by the solid line in FIG. 11, and when used, is opened so as to project from the side of the main body of the apparatus as shown by the dot-dot-dash line in FIG. 11.

Main body ejection section 160 in this example has an ejection platform sensor 1103 that is turned on and off coupled with opening and closing of main body ejection platform 1101. This ejection platform sensor 1103 detects whether or not main body ejection platform 1101 is opened.

In FIG. 11, ejection platform sensor 1103 is turned on when main body ejection platform 1101 is opened. Then, when ejection platform sensor 1103 is turned on, ejection path switching lug 401 of ejection mode switching section 400 described above swings from the position shown by the solid line in FIG. 11 to the position shown by the dotted line, and the ejection path of recording paper P that has undergone image formation is switched to main body ejection path 184a.

In FIG. 11, when ejection path switching lug 401 is in the position shown by the solid line, the ejection path of recording paper P that has undergone image formation is switched to top ejection path 183a.

Thus, in this image forming apparatus 1100 according to Embodiment 4, main body ejection platform 1101 projects from the side of the main body of the apparatus, but since this main body ejection platform 1101 is used only in low-frequency manual copying mode, it can be housed in the main body of the apparatus when not required. Also, since a space is not formed in the waist section of the main body of this image forming apparatus 1100, the housing structure, exterior configuration, and so forth are not complicated.

Other configuration elements and operations in image forming apparatus 1100 of this example are similar to configuration elements and operations of image forming apparatus 100 according to Embodiment 1, and therefore descriptions thereof are omitted here.

(Embodiment 5)

Next, an image forming apparatus according to Embodiment 5 of the present invention will be described.

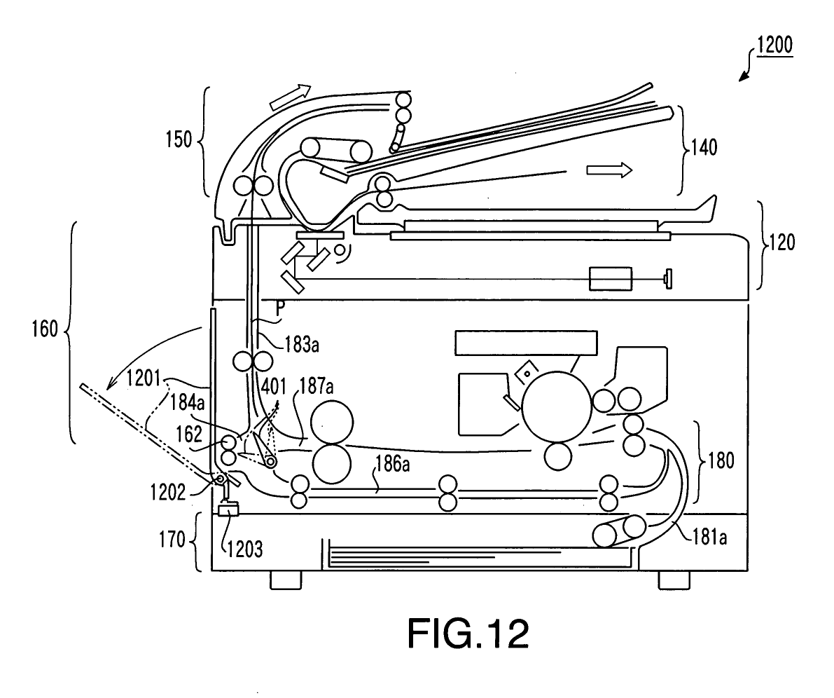

FIG. 12 is a schematic cross-sectional drawing showing the overall configuration of an image forming apparatus according to Embodiment 5. As shown in FIG. 12, this image forming apparatus 1200 has a configuration in which a main body ejection platform 1201 of main body ejection section 160 also serves as a manual tray used in manual feeding provided on the side of the main body of the apparatus.

In FIG. 12, this main body ejection platform 1201 is attached to the side of the main body of the apparatus so as to open and close freely by means of a spindle 1202. This main body ejection platform 1201 is normally closed against the side of the main body of the apparatus as shown by the solid line in FIG. 12, and when used, is opened so as to project from the side of the main body of the apparatus as shown by the dot-dot-dash line in FIG. 12.

Main body ejection section 160 in this example has an ejection platform sensor 1203 that is turned on and off coupled with opening and closing of main body ejection platform 1201. This ejection platform sensor 1203 detects whether or not main body ejection platform 1201 is opened.

In FIG. 12, ejection platform sensor 1203 is turned on when main body ejection platform 1201 is opened. Then, when ejection platform sensor 1203 is turned on, ejection path switching lug 401 of ejection mode switching section 400 described above swings from the position shown by the solid line in FIG. 12 to the position shown by the dot-dot-dash line, and the ejection path of recording paper P that has undergone image formation is switched to main body ejection path 184a.

In FIG. 12, when ejection path switching lug 401 is in the position shown by the solid line, the ejection path of recording paper P that has undergone image formation is switched to top ejection path 183a. Also, in FIG. 12, when ejection path switching lug 401 is in the position shown by the dotted line, recording paper P that has undergone image formation is switched to reverse transport path 186a that transports recording paper P to feed path 181a with its image formation surface reversed.

Thus, with this image forming apparatus 1200 according to Embodiment 5, since main body ejection platform 1201 also serves as the above-described manual tray, main body ejection section 160 can be provided without incurring cost or requiring space. Also, as image forming apparatus 1200 shown in the figure has a configuration in which ejection path switching lug 401 also serves as reverse switching lug 188 that switches the transport path of recording paper P that has temporarily left ejection transport path 187a toward reverse transport path 186a, the configuration of transporting system 180 can be simplified.

Other configuration elements and operations in image forming apparatus 1200 of this example are similar to configuration elements and operations of image forming apparatus 1100 according to Embodiment 4, and therefore descriptions thereof are omitted here.

In addition to providing the aforementioned effects, image forming apparatuses 100, 900, 1100, and 1200 according to the embodiments of the present invention can store image information from an external source in memory 190 functioning as a storage section (see FIG. 1) as described above, so that, for example, the aforementioned image information can be received even during operation of reading section 120 without incurring a waiting period.

These image forming apparatuses 100, 900, 1100, and 1200 can also be used in cases where a source document image read by reading section 120 is not printed immediately, but is transmitted to an external destination as electronic data. In such cases, source document cover 122 is latched to the main body of the apparatus after the user has removed a sheet source document S or book source document BO. It goes without saying that main body ejection mode is not entered in such cases since an image forming directive is not issued.

With these image forming apparatuses 100, 900, 1100, and 1200, there are many cases in which one-shot copying is performed that is, only a single copy is made in manual copying mode, and therefore the capacity of memory 190 need not be large and the user only has to wait a short time. In such cases, if source document cover 122 is latched to the main body of the apparatus under the kind of conditions shown in FIG. 6, there will be no instances in which a sheet source document S is trapped between source document holding platform 121 and source document cover 122 and cannot be removed.

In these image forming apparatuses 100, 900, 1100, and 1200, when a feed source document O is copied in automatic copying mode using automatic document feeder 140, the presence of this feed source document is detected by feed source document sensor 146, enabling the ejection mode of recording paper P that has undergone image formation to be switched easily to top ejection mode. In this kind of automatic copying mode employing automatic document feeder 140, the user does not open source document cover 122 and place a source document on source document holding platform 121 manually, and therefore source document cover 122 can be latched to the main body of the apparatus immediately, and sheet jams of recording paper P that has undergone image formation can be prevented.

In these image forming apparatuses 100, 900, 1100, and 1200, the condition “only when the closed state of source document cover 122 is detected by cover position sensor 503” can be further added as a condition under which source document cover 122 is latched to the main body of the apparatus.

With these image forming apparatuses 100, 900, 1100, and 1200, if source document cover 122 is detected by cover position sensor 503 not to be in the closed state, a “Please close source document cover” message may be displayed on the operation panel (not shown) of the main body of the apparatus.

With image forming apparatuses 1100 and 1200, if ejection platform sensor 1103 or 1203 detects that main body ejection platform 1101 or 1201 is not in the open state in manual copying mode, it is possible to display “Please open main body ejection platform” on the operation panel of the main body of the apparatus, store image information read by reading section 120 in memory 190, and wait for an image forming operation by image forming section 130 until main body ejection platform 1101 or 1202 is opened.

With image forming apparatuses 100, 900, 1100, and 1200 according to the embodiments of the present invention, examples have been described in which an electrophotographic method is used as the image forming method of image forming section 130, but it goes without saying that that the present invention can also be applied to similar image forming apparatuses that use a different image forming method, such as an ink-jet method.

The present invention is not limited to the above-described embodiments, and various variations and modifications may be possible without departing from the scope of the present invention.

This application is based on Japanese Patent Application No. 2004-124748 filed on Apr. 20, 2004, the entire content of which is expressly incorporated by reference herein.

1. An image forming apparatus that has:
a receiving section that receives image information from an external source;
a reading section that is equipped with a source document holding platform and reads a source document placed on said source document holding platform;
an image forming section that forms an image on a recording medium;
a top ejection section positioned on an upper part of an apparatus main body that holds a recording medium that has undergone image formation; and
a main body ejection section positioned in a different area of an apparatus main body from said top ejection section that holds a recording medium that has undergone image formation;
said image forming apparatus comprising an ejection mode switching section that switches to a top ejection mode in which a recording medium that has undergone image formation is ejected into said top ejection section in case of image formation by means of image information from said external source, and switches to a main body ejection mode in which a recording medium that has undergone image formation is ejected into said main body ejection section in case of image formation by means of image information from said reading section.

2. The image forming apparatus according to claim 1, further comprising:
a freely opening and closing source document cover that covers said source document placed on said source document holding platform; and
a source document cover lock section that latches said source document cover in a predetermined position in said top ejection mode.

3. The image forming apparatus according to claim 2, wherein said source document cover lock section latches said source document cover in a predetermined position following an elapse of a predetermined time after operation of said reading section ends when said reading section is operating when there has been a directive for image forming by means of image information from said external source.

4. The image forming apparatus according to claim 2, further comprising a manual source document detection section that detects presence or absence of a source document placed on said source document holding platform;
wherein said source document cover lock section latches said source document cover in a predetermined position after operation of said reading section ends and said manual source document detection section detects that there is no source document placed on said source document holding platform when said reading section is operating when there has been a directive for image forming by means of image information from said external source.

5. The image forming apparatus according to claim 1, wherein said main body ejection section is positioned in a waist section of said apparatus main body.

6. The image forming apparatus according to claim 1, wherein said main body ejection section is positioned on a side of said apparatus main body.

7. The image forming apparatus according to claim 6, further comprising a manual tray that is positioned on an apparatus main body side and is used in manual feeding;
wherein said main body ejection section is positioned on a same apparatus main body side as said manual tray.

8. The image forming apparatus according to claim 6, wherein said main body ejection section also serves as a manual tray used in manual feeding.

9. The image forming apparatus according to claim 1, further comprising a storage section that stores image information from said external source.

10. The image forming apparatus according to claim 9, further comprising a manual source document detection section that detects presence or absence of a source document placed on said source document holding platform;
wherein a directive for image forming by means of image information from said external source stored in said storage section is issued after operation of said reading section ends and said manual source document detection section detects that there is no source document placed on said source document holding platform.

11. An image forming apparatus that has:
a reading section that is equipped with a source document holding platform and reads a source document placed on said source document holding platform;
an automatic document feeder that is equipped with a source document feeding section and reads a feed source document fed by said source document feeding section;
an image forming section that forms an image on a recording medium;
a top ejection section positioned on an upper part of an apparatus main body that holds a recording medium that has undergone image formation; and
a main body ejection section positioned in a different area of an apparatus main body from said top ejection section that holds a recording medium that has undergone image formation;
said image forming apparatus comprising an ejection mode switching section that switches to a top ejection mode in which a recording medium that has undergone image formation is ejected into said top ejection section in case of image formation by means of image information from said automatic document feeder, and switches to a main body ejection mode in which a recording medium that has undergone image formation is ejected into said main body ejection section in case of image formation by means of image information from said reading section.

12. The image forming apparatus according to claim 11, further comprising a receiving section that receives image information from an external source;
wherein said ejection mode switching section switches to a top ejection mode in which a recording medium that has undergone image formation is ejected into said top ejection section in case of image formation by means of image information from said external source.

13. The image forming apparatus according to claim 11, further comprising a feed source document detection section that detects presence or absence of a feed source document to be fed by said automatic document feeder;
wherein said ejection mode switching section switches to said top ejection mode when said feed source document detection section detects that there is a feed source document to be fed by said automatic document feeder, and switches to said main body ejection mode when said feed source document detection section detects that there is no feed source document to be fed by said automatic document feeder.

14. The image forming apparatus according to claim 11, further comprising:
a source document cover that covers said source document placed on said source document holding platform; and
a source document cover lock section that latches said source document cover in a predetermined position in said top ejection mode.

15. The image forming apparatus according to claim 11, wherein said main body ejection section is positioned in a waist section of said apparatus main body.

16. The image forming apparatus according to claim 11, wherein said main body ejection section is positioned on a side of said apparatus main body.

17. The image forming apparatus according to claim 16, further comprising a manual tray that is positioned on an apparatus main body side and is used in manual feeding;
wherein said main body ejection section is positioned on a same apparatus main body side as said manual tray.

18. The image forming apparatus according to claim 16, wherein said main body ejection section also serves as a manual tray used in manual feeding.

19. The image forming apparatus according to claim 11, further comprising a storage section that stores image information from said external source.

20. The image forming apparatus according to claim 19, further comprising a manual source document detection section that detects presence or absence of a source document placed on said source document holding platform;
wherein a directive for image forming by means of image information from said external source stored in said storage section is issued after operation of said reading section ends and said manual source document detection section detects that there is no source document placed on said source document holding platform.

21. The image forming apparatus according to claim 2, further comprising a source document cover position detection section that detects an open or closed state of said source document cover;
wherein said source document cover is latched in a predetermined position by said source document cover lock section only when said source document cover position detection section is detecting that said source document cover is in a closed state.

22. The image forming apparatus according to claim 2, wherein said ejection mode switching section is composed of an ejection path switching section that switches an ejection path of said recording medium that has undergone image formation to an ejection path corresponding to said top ejection mode or said main body ejection mode coupled with opening/closing operations of said source document cover.
